(19) United States
(12) Patent Application Publication
(10) Pub. No.: US 2014/0003072 A1
(43) Pub. Date: Jan. 2, 2014

(54) VEHICULAR REAR PANEL

(71) Applicant: KOITO MANUFACTURING CO., LTD., Tokyo (JP)

(72) Inventors: Hideaki YAMAMOTO, Shizuoka-shi (JP); Daisuke MOCHIZUKI, Shizuoka-shi (JP); Takanori NAMBA, Shizuoka-shi (JP); Naoki SUGIURA, Shizuoka-shi (JP); Tomoaki OTANI, Shizuoka-shi (JP); Seiichiro YAGI, Shizuoka-shi (JP); Koji UCHINO, Shizuoka-shi (JP); Hiromi NAKAMURA, Shizuoka-shi (JP); Masaaki NAKABAYASHI, Shizuoka-shi (JP)

(21) Appl. No.: 13/927,384

(22) Filed: Jun. 26, 2013

(30) Foreign Application Priority Data
Jun. 29, 2012 (JP) 2012-147036

(51) Int. Cl. B60Q 1/26

(52) U.S. Cl. CPC B60Q 1/268
USPC 362/503

(57) ABSTRACT

A vehicular rear panel having a new configuration is provided. The vehicular rear panel according to an aspect of the present disclosure is made of a resin material and disposed on the rear vehicle body part. The vehicular rear panel includes: a light source which is at least partially disposed in the inside of the vehicular rear panel, a circuit which is at least partially provided in the vehicular rear panel to supply electric power to the light source, and a light emitting unit configured to emit light source light to the rear of the vehicle.

### CROSS-REFERENCE TO RELATED APPLICATIONS

This application is based on and claims priority from Japanese Patent Application No. 2012-147036 filed on Jun. 29, 2012 with the Japan Patent Office and the disclosure of which is incorporated herein in its entirety by reference.

### TECHNICAL FIELD

The present disclosure relates to a vehicular rear panel, especially a vehicular rear panel which is mounted on a vehicle such as, e.g. a car.

### BACKGROUND

Japanese Patent Laid-Open Publication No. H5-69777 discloses a high-mount stop lamp which is attached to a rear wind shield of a vehicle, i.e., an inner upper part of the rear window and used as a stop lamp.

### SUMMARY

Recently, the resinification of a vehicular rear panel has been sought for the purpose of such as, for example, weight lightening of vehicles. In such a circumstance, the present inventors have repeatedly conducted a careful research regarding a vehicular rear panel formed of a resin material and, as a result, have obtained a vehicular rear panel with a new configuration which is provided with a function of a vehicular lamp such as, for example, a stop lamp.

The present disclosure has been made based on the present inventors' such recognition and an aspect of the present disclosure is to provide a vehicular rear panel with a new configuration.

According to an aspect of the present disclosure, there is provided a vehicular rear panel which is made of a resin material and disposed at a rear vehicle body portion. The vehicular rear panel includes a light source which is at least partially disposed in the inside of the vehicular rear panel, a circuit which is at least partially provided in the vehicular rear panel to supply electric power to the light source, and a light emitting unit configured to emit light from the light source to the rear side of the vehicle.

According to the above-described aspect, a vehicular rear panel with a new configuration may be provided.

In another aspect, the vehicular rear panel may be provided with a rear window part and the rear window part may be provided with the above-described light source, circuit, and light emitting unit. Also, in the present aspect, the rear window part has a curved portion which causes the scenery to be discontinuous when viewed from a driver side and the above-described light source, circuit, and light emitting unit may be provided at the curved portion. Further, in any of the above-described aspects, the vehicular rear panel may be provided with a light shielding part configured to suppress the light from the light source from proceeding toward the front of the vehicle. Furthermore, in any of the above-described aspects, one end of the light guiding unit may be disposed in the vicinity of the light source installed on the vehicle body and the other end may be disposed in the vicinity of the light emitting unit. With above-described aspects, a vehicular rear panel with a new configuration may also be provided.

According to the present disclosure, a vehicular rear panel with a new configuration may be provided.

The above-described summary is for illustration purposes only and does not intend to limit in any ways. In addition to the illustrative embodiments, examples, and features described above, additional embodiments, examples, and features will become apparent by referring to the drawings and the following detailed description.

### BRIEF DESCRIPTION OF THE DRAWINGS

FIG. 1A is a schematic front view illustrating a configuration of a vehicular rear panel according to a first exemplary embodiment. FIG. 1B is a cross-sectional view taken along line A-A in FIG. 1A.

FIG. 2A is a schematic perspective view illustrating a configuration of a light source and an FPC of a vehicular rear panel according to a modified example 1.

FIG. 2B is a schematic cross-sectional view illustrating a configuration in the vicinity of a luminous part of the vehicular rear panel according to a modified example 2.

FIG. 3A is a schematic front view illustrating a configuration of a vehicular rear panel according to a modified example 3. FIG. 3B is a schematic view describing the attachment of a light source module to a rear window part.

FIG. 4A is a schematic front view illustrating a configuration of a vehicular rear panel according to a modified example 4. FIG. 4B is a cross-sectional view taken along line B-B in FIG. 4A.

FIG. 5A is a schematic front view illustrating a configuration of a vehicular rear panel according to a modified example 5. FIG. 5B is a cross-sectional view taken along line C-C in FIG. 5A.

FIG. 6A is a schematic front view illustrating a configuration of a vehicular rear panel according to a second exemplary embodiment. FIG. 6B is a cross-sectional view taken along line D-D in FIG. 6A. FIG. 6C is a rear view illustrating a vehicular rear panel in a state in which a masking material is provided.

FIG. 7A is a schematic side view illustrating a configuration of the rear part of the vehicle on which a vehicular rear panel according to a third exemplary embodiment is mounted. FIG. 7B is a schematic vertical cross-sectional view illustrating a configuration in the vicinity of a curved portion of a rear window part. FIG. 7C is a schematic front view illustrating a configuration of a vehicular rear panel according to a third exemplary embodiment.

FIG. 8A is a schematic front view illustrating a configuration of a vehicular rear panel according to a fourth exemplary embodiment. FIG. 8B is a cross-sectional view taken along line E-E in FIG. 8A.

FIG. 9A is a schematic front view illustrating a configuration of a vehicular rear panel according to a fifth exemplary embodiment. FIG. 9B is a schematic perspective view illustrating a configuration of a light source implementation film. FIG. 9C is a cross-sectional view taken along line F-F in FIG. 9A.

FIG. 10A is a cross-sectional view describing a manufacturing method of a rear window part. FIG. 10B is a cross-sectional view describing a manufacturing method of a rear window part of a vehicular rear panel according to a modified example 6.

### DETAILED DESCRIPTION

In the following detailed descriptions, reference will be made to the accompanying drawings which form a part of the present application. The illustrative embodiments described in the detailed descriptions, drawings, and the claims do not intend to limit. Other embodiments may be used and other modified examples may be made without departing from the spirit or scope of the subject matter represented in the present application.

Hereinafter, detailed descriptions of the present disclosure will be made with reference to the drawings based on the condign exemplary embodiments. The same or equivalent components, members, and processings that are represented in each of the drawings are assigned with the same symbols and repeated descriptions thereof will be properly omitted. Also, the exemplary embodiments exemplify the present disclosure rather than limiting the present disclosure and it shall not be concluded that all the features or the combinations described in the exemplary embodiments are necessarily essential to the present disclosure.

### First Exemplary Embodiment

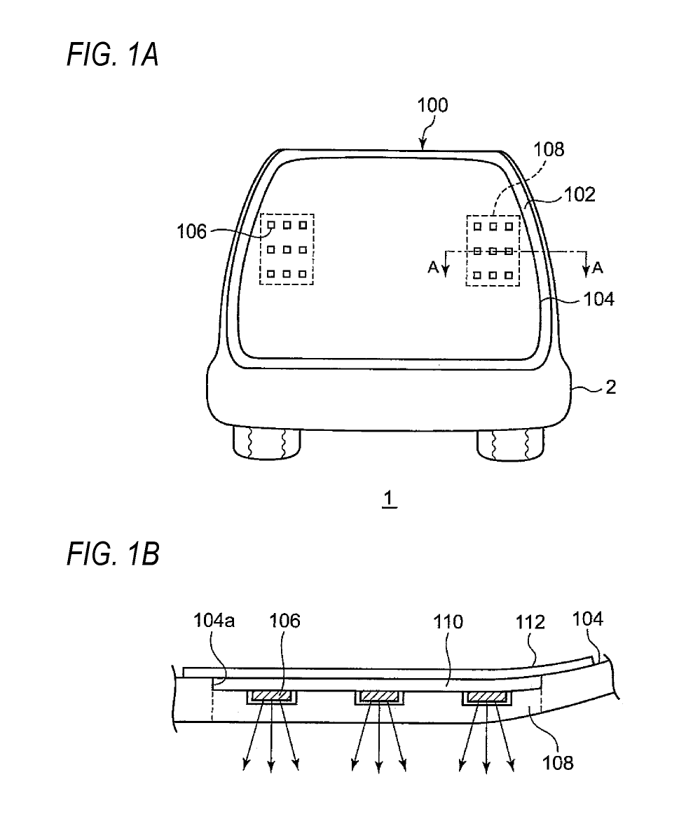

FIG. 1A is a schematic front view illustrating a configuration of a vehicular rear panel according to the first exemplary embodiment. FIG. 1A illustrates a state in which a vehicle 1 equipped with a vehicular rear panel 100 is viewed from the rear side. FIG. 1B is a cross-sectional view taken along line A-A in FIG. 1A. The vehicular rear panel 100 according to the present exemplary embodiment is disposed on a rear vehicle body part 2 of the vehicle 1 and made of a resin material. The vehicular rear panel 100 is made of a material such as, e.g., polycarbonate resin or acrylic resin. The vehicular rear panel 100 of the present disclosure forms a retractable backdoor and shields an opening 4 of the rear vehicle body part 2.

The vehicular rear panel 100 is provided with a backdoor outer panel 102 and a rear window part 104. That is, the vehicular rear panel 100 is configured by the backdoor panel 102 and the rear window part 104. The backdoor panel 102 is a frame having an opening and the opening is provided with the rear window part 104. The rear window part 104 of the present exemplary embodiment is formed with a transparent resin material such as, e.g., polycarbonate resin or acrylic resin. The rear window part 104 is a region which may be used for a driver's rear visibility. Also, in the vehicular rear panel 100, the backdoor panel 102 and the rear window part 104 may be integrally formed. In this case, for example, by forming a transparent resin material into a sheet of plate and conducting a coloring on a region which is to be a backdoor panel 102, the vehicular rear panel 100 integrally formed with the backdoor outer panel 102 and the rear window part 104 may be obtained. Further, the whole vehicular rear panel 100 may be transparent. In this case, the whole vehicular rear panel 100 forms the rear window part 104.

Further, the vehicular rear panel 100 is provided with a light source 106 which is at least partially disposed in the inside of the vehicular rear panel 100, a light emitting unit 108 configured to emit light source light to the rear of the vehicle, and a flexible printed circuit (hereinafter, referred to as “FPC 110”) 110 which is at least partially provided in the vehicular rear panel 100 to supply electric power to the light source 106 as a wiring. For the light source 106, for example, a light-emitting element such as, e.g., LED (“light-emitting diode”), LD (“laser diode”), organic or inorganic EL (“electro luminescence”) may be used. In the present disclosure, the light source 106, the FPC 110, and the light emitting unit 108 are provided to the rear window part 104. More specifically, a concave portion 104a is formed on a predetermined region of the surface of the front side of the vehicle (vehicle interior side or vehicle compartment side) of the rear window part 104, i.e. at the region of each of left and right ends of the rear window part 104. The concave portion 104a accommodates a light source module in which a plurality of light sources 106 are mounted on a transparent FPC 110 of a sheet shape. A transparent resin film 112 is bonded to the surface of the front side of the vehicle of the rear window part 104 such that it covers the concave portion 104a. Accordingly, a plurality of light sources 106 and the FPC 110 are sealed in the concave portion 104a. The region of the rear window part 104 where the light source 106 overlaps or the concave portion 104a overlaps when viewed from the rear side of the vehicle forms the light emitting unit 108. When viewed from the exterior side of the vehicle, the extending region of the light emitting unit 108 forms a luminous part.

Each light source 106 is electrically connected to the FPC 110. Also, the FPC 110 is electrically connected to an electronic circuit (not illustrated) installed in the vehicle body side or vehicular rear panel 100. ON/OFF of the light source 106 is controlled by the electronic circuit while the light source 106 is in a sealed state in the concave portion 104a. The light source 106 is disposed such that the light emitting surface thereof faces the rear side of the vehicle. The light emitted from the light source 106 is emitted to the surface of the rear side of the vehicle (vehicle exterior side) of the light emitting unit 108 and radiated to the rear side of the vehicle. In the present exemplary embodiment, the light source 106 emits red light. In addition, the light source 106, the FPC 110, and the light emitting unit 108 serve as a stop lamp and/or a tail lamp as a vehicular beacon lamp. Also, the light source 106 may emit amber light and the light source, FPC 110, and the light emitting unit 108 may serve as a turn signal lamp. Further, the light source 106, FPC 110, and the light emitting unit 108 may be disposed at the upper central part and serve as a high mount stop lamp. The number and the arrangement of light sources 106 are not limited to those illustrate in the drawing and may configure various lamps.

The resin film 112, the FPC 110, and the light emitting unit 108 are transparent. Thus, the vehicular rear panel 100 has a so-called see-through configuration which enables a driver to visually recognize the rear side of the vehicle through the extending region of the resin film 112, the FPC 110, and the light emitting unit 108.

As described above, the vehicular rear panel 100 of the present exemplary embodiment is provided with a light source 106 which is at least partly disposed in the inside of the vehicular rear panel 100, an FPC 110 which is at least partly provided in the vehicular rear panel 100 and configured to supply electrical power to the light source 106 as a wiring, and a light emitting unit 108 configured to emit the light source light to the rear of the vehicle. That is, the vehicular rear panel 100 of the present exemplary embodiment has a configuration in which a vehicular lamp is integrally provided. Accordingly, the vehicular rear panel 100 with a new configuration may be provided. Also, according to the vehicular rear panel 100 of the present exemplary embodiment, for example, the number of components, the number of assembling steps and the manufacturing cost of the vehicular rear panel or the vehicle may be reduced since configurations and members required to attach the vehicular lamp to the backdoor or the vehicle body may be omitted.

In addition, in the present exemplary embodiment, the rear window part 104 is made of a resin material. Thus, weight lightening of the vehicular rear panel 100 may be further facilitated. Further, since the backdoor outer panel 102 and the rear window part 104 may be integrally formed, the number of components, the number of assembling steps, and the manufacturing cost of the vehicular rear panel may be further reduced. Furthermore, the rear window part 104 may be simply formed with a concave portion 104a configured to accommodate the light source since the concave portion 104a may be easily processed on the rear window part 104. Also, in the present exemplary embodiment, the light source 106, the FPC 110 and the light emitting unit 108 are provided in the rear window part 104. Accordingly, the design flexibility of the vehicular lamp or the design flexibility of the vehicle may be increased and the decorativenss of the vehicular rear panel 100 may be enhanced. In the present exemplary embodiment, it may look as if the luminous part is floating in the air since the surroundings of the light emitting unit 108 are transparent.

As for the vehicular rear panel 100 according to the above-described first exemplary embodiment, modified examples 1 to 5 described below may be exemplified.

### MODIFIED EXAMPLE 1

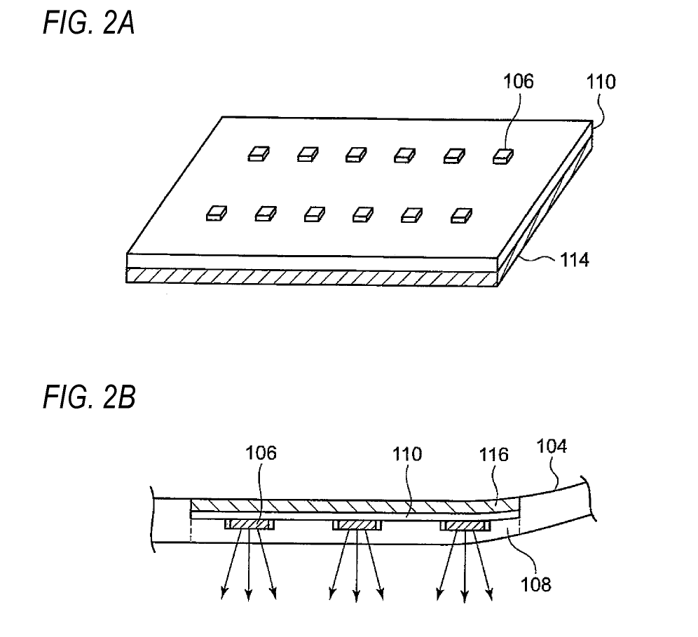

FIG. 2A is a schematic perspective view illustrating a configuration of a light source and an FPC of the vehicular rear panel according to the modified example 1. The vehicular rear panel 100 according to the modified example 1 is provided with a light shielding part 114 on the rear side of the FPC 110 where a plurality of light sources 106 are mounted. The light shielding part 114 is configured to suppress light from the light source from proceeding to the front side of the vehicle. The light shielding part 114 is constituted by, for example, a liquid crystal shutter. In the present modified example, a film-shaped liquid crystal shutter is stacked on the surface which is opposite to the surface where the light sources 106 of the FPC 110 are mounted. The liquid crystal shutter is turned ON in a state where the light sources 106 are in the ON state so that the penetration amount of the light decreases. Especially, since the radiation of red light to the front side of the vehicle may cause, for example, a pedestrian or a driver of another vehicle to misunderstand the front-rear direction of the vehicle in a configuration in which red light is radiated from the light emitting unit 108, it is preferable that substantially all the light is shielded to an extent that the right is not visible to, for example, a pedestrian. Also, the liquid crystal shutter is turned OFF in a state of light off of the light source and the penetration amount of the light increases. For example, the liquid crystal shutter becomes transparent when the light source 106 is in the OFF state.

Accordingly, the radiation of the light to the front side of the vehicle may be suppressed when the light sources 106, the FPC 110, and the light emitting unit 108 serve as a beacon lamp. Also, when the light source 106s, the FPC 110, and the light emitting unit 108 are not serving as a beacon lamp, a see-through configuration in which the rear side of the vehicle is visible to the driver may be obtained. Further, the light shielding part 114 formed with the film-shaped liquid crystal shutter may be disposed between the FPC 110 and the resin film 112 or in the front side of the vehicle. In addition, the light shielding part 114 may be disposed to be spaced from the resin film 112 as long as the light shielding part may exhibit the light shielding effect. Furthermore, the light shielding part 114 may be a metal layer formed by depositing for example, aluminum or silver to the surface of the FPC 110, a resin layer formed from a colored resin material or a paint film formed by applying a colored paint. When the light shielding part 114 is formed from the metal layer, the metal layer may be served as a reflector to radiate the light from the light source to the rear side of the vehicle.

### MODIFIED EXAMPLE 2

FIG. 2B is a schematic cross-sectional view illustrating a configuration in the vicinity of the luminous part of the vehicular rear panel according to the modified example 2. In the vehicular rear panel 100 according to the modified example 2, an FPC 110 mounted with light sources 106 is accommodated in the concave portion 104a formed on the rear window part 104. A sealing layer 116 formed from a transparent sealing material is provided in the concave portion 104a. The sealing layer 116 may be formed, for example, by insert molding using a sealing material which may be used for injection molding. In the present modified example, the light sources 106 and the FPC 110 are sealed in the rear window part 104 by the sealing layer 116 instead of the resin film 112. Since the sealing layer 116 is transparent, a see-through configuration in the extending region of the light emitting unit 108 may also be implemented by the present modified example.

### MODIFIED EXAMPLE 3

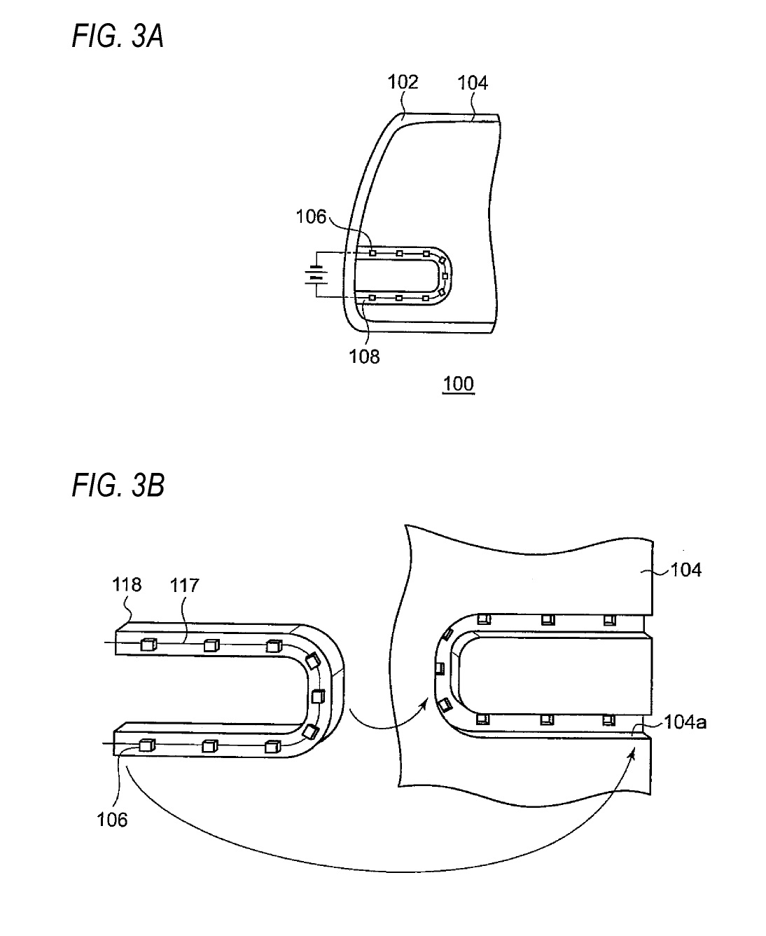

FIG. 3A is a schematic front view illustrating a configuration of the vehicular rear panel according to the modified example 3. FIG. 3B is a schematic view describing the attachment of a light source module to a rear window part. Also, FIG. 3A illustrates a half of the vehicular rear panel 100 in the widthwise direction of the vehicle. A portion omitted in the illustration has a shape which is axisymmetric to the illustrated portion. Further, FIG.3A illustrates a state in which the rear window part 104 is viewed from the front side of the vehicle.

The vehicular rear panel 100 according to the modified example 3 is provided with a light source module, in which a plurality of light sources 106 are mounted on a support 118, in the concave portion 104a provided on the surface of the front side of the vehicle of the rear window part 104. The light source module has a configuration in which the light sources 106 are mounted on the support (a rigid substrate) 118 formed by forming a wiring 117 for power supply on a colored or transparent and rigid base material by electric conductor printing. Alternatively, the light source module may have a configuration in which the light sources 106 are mounted on the support 118 formed by a colored or transparent FPC as a wiring. Further, the light source module may be an injection molded product (a molding injection device (MID)). According to the present modified example, the deterioration of a driver's rear visibility caused when the support 118 is opaque may be reduced since the support 118 has a line shape. Also, the shape of the support 118 is not limited to a substantially U-shape as illustrated in FIG. 3A and may have another shape such as, e.g., a circular or polygonal shape.

### MODIFIED EXAMPLE 4

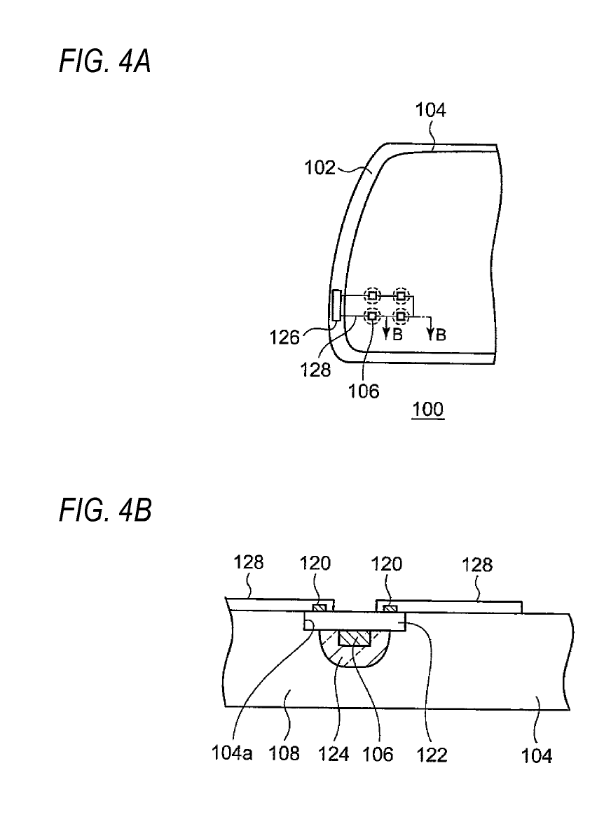

FIG. 4A is a schematic front view illustrating a configuration of the vehicular rear panel according to the modified example 4. FIG. 4B is a cross-sectional view taken along line B-B in FIG. 4A. Also, FIG. 3A illustrates a half of the vehicular rear panel 100 in the widthwise direction of the vehicle. A portion omitted in the illustration has a shape which is axisymmetric to the illustrated portion. In the vehicular rear panel 100 according to the modified example 4, each light source 106 is embedded in the rear window part 104 and electrically connected to the wiring formed on the surface of the rear window part 104. More specifically, the light source 106 is mounted on a substrate 122 where electrodes 120 are provided on the rear surface thereof A plurality of concave portions 104a are formed which respectively correspond to a plurality of light sources 106 on the surface of the front side of the vehicle of the rear window part 104. Each concave portion 104a accommodates one light source 106 and a filler material 124 is filled between the wall of the concave portion 104a and the light source 106. At that time, positional alignment of the light source 106 may be made with and the wall of the concave portion 104a and the substrate 122.

While the light source 106 is accommodated in the concave portion 104a, for example, a metal deposition processing is executed at a predetermined region of the surface of the front side of the vehicle of the rear window part 104. Accordingly, a wiring 128 electrically connected to a circuit substrate 126 provided on the backdoor panel 102 and the electrodes 120 of each light source 106 and configured to supply electric power to the light source 106 are formed. According to the modified example, the design flexibility of the arrangement of the light sources 106 may be enhanced. Also, manufacturing costs may be reduced.

### MODIFIED EXAMPLE 5

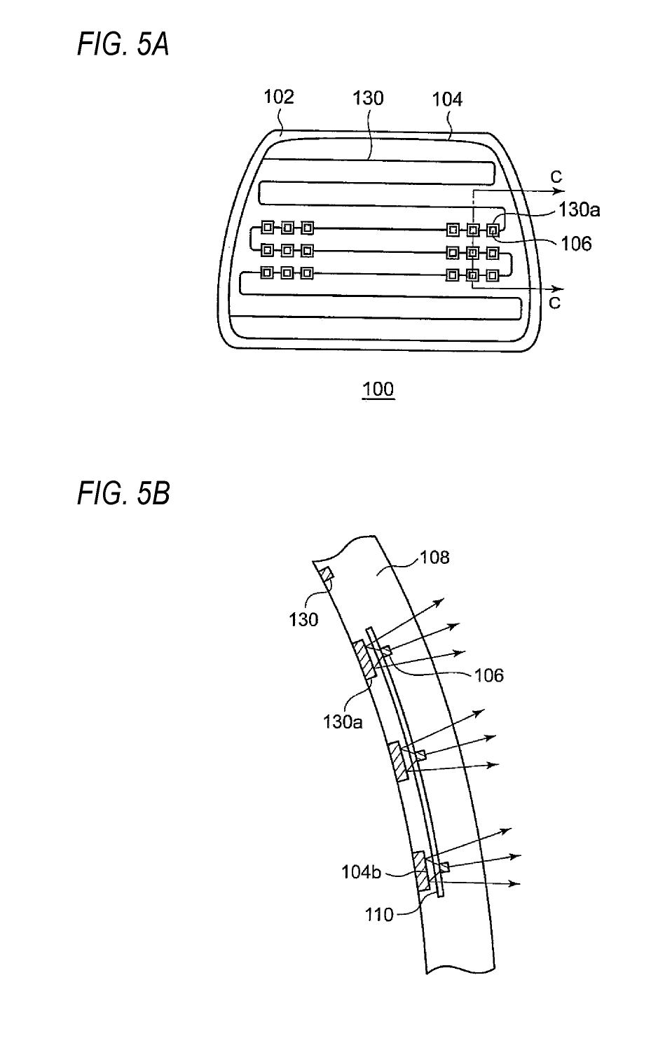

FIG. 5A is a schematic front view illustrating a configuration of the vehicular rear panel according to the modified example 5. FIG. 5B is a cross-sectional view taken along line C-C in FIG. 5A. As for the vehicular rear panel 100 according to the modified example 5, the light source 106 is disposed at a location where a defogger (hot wire) 130 formed on the rear window part 104 overlaps in the longitudinal direction of the vehicle. The defogger 130 may be formed by depositing a metal such as, e.g., aluminum or silver on the surface of front side of the vehicle of the rear window part 104. The defogger 130 is provided with wide part 130sa on the rear surface of the light sources 106. When viewed in the longitudinal direction of the vehicle, each of the wide parts 130a has a larger area than that of a corresponding one the light sources 106 so that the light sources 106 are disposed within the wide parts 130a, respectively. By disposing the wide parts 130a on the surfaces of the front side of the vehicle of the light sources 106, the radiation of the light from the light sources 106 to the front side of the vehicle may be suppressed. That is, the wide parts 130a serve as a light shielding part.

Also, by the wide parts 130a, the light radiated from the light sources 106 toward the front side of the vehicle or the light reflected from the surface of the rear side of the vehicle of the light emitting unit 108 to the front side of the vehicle may be reflected to the rear side of the vehicle. The light directed toward the front side of the vehicle from the surfaces of the rear side of the vehicle of the light sources 106 and the light emitting unit 108 reaches the wide parts 103a through the transparent FPC 110. Also, the light directed to the rear side of the vehicle from the wide parts 130a reaches the surface of the rear side of the vehicle of the light emitting unit 108 through the transparent FPC 110. In the present modified example, step-shaped concave portions 104b are provided on the surfaces of the front side of the vehicle of the rear window part 104 and the wide parts 130a are accommodated in the concave portions 104b, respectively. Thus, the light distribution of the light source light may be controlled by the wide parts 130a. Also, the wide parts 130a may not be embedded in the rear window part 104 and may have, for example, a curved shape.

### Second Exemplary Embodiment

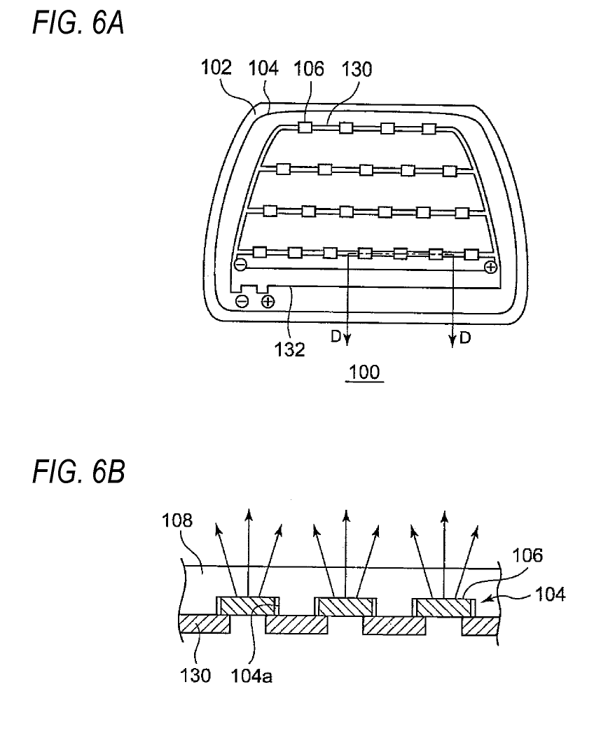

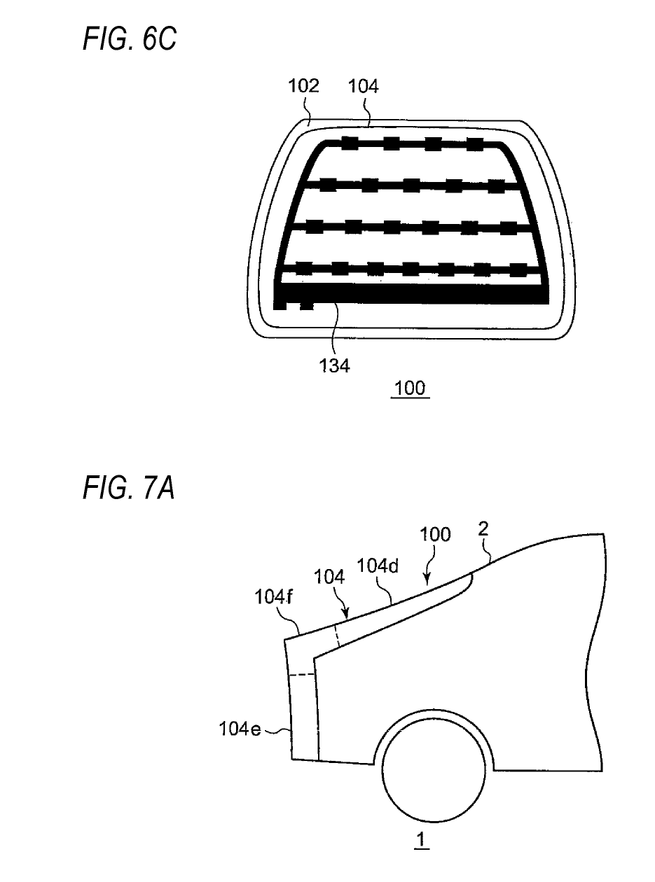

The vehicular rear panel according to the second exemplary embodiment has a configuration in which a light source is connected to a hot wire of a defogger. Hereafter, descriptions about the vehicular rear panel according to the present exemplary embodiment will be made based on the features different from those of the first exemplary embodiment. Also, the same configurations as those of the first exemplary embodiment will be assigned with the same symbols and the descriptions and illustrations of the configurations and the effects will be omitted. FIG. 6A is a schematic front view illustrating a configuration of the vehicular rear panel according to the second exemplary embodiment. FIG. 6B is a cross-sectional view taken along line D-D in FIG. 6A. FIG. 6C is a rear view illustrating the vehicular rear panel in a state in which a masking material configured to cover the light source and the defogger is provided. FIG. 6C illustrates a state in which the vehicular rear panel is viewed from the front side of the vehicle.

The vehicular rear panel 100 according to the second exemplary embodiment has a configuration in which a circuit pattern of light sources 106 is formed on the rear window part 104 which is made of a resin material and a light source module and the rear window part 104 are integrally formed. Also, in the present exemplary embodiment, the defogger 130 is used for the circuit pattern. More specifically, the light sources 106 are accommodated in concave portions 104a formed on the rear window part 104, respectively. Further, the defogger 130 is connected to the electrodes of the light sources 106. The electrodes of adjacent light sources 106 are electrically connected by hot wires of the defogger 130. That is, the hot wires forming the defogger 130 and the light sources 106 are disposed alternately. Furthermore, the end portions of the hot wires are connected to an electronic circuit 132. In the vehicular rear panel 100 of the present exemplary embodiment, the hot wires of the defogger 130 serve as a wiring configured to supply electric power to the light sources 106. Also, the hot wires of the defogger 130 serve as a resistance in an ON/OFF control circuit of the light sources 106. By using the defogger 130 as the circuit pattern of the light sources 106 as described above, the number of components, the number of assembling processes, and the manufacturing cost of the vehicular rear panel may be reduced.

A colored, for example, black masking material 134 may be provided on the rear surface (of the front side of the vehicle) of the light source 106 and the defogger 130. The masking material 134 is formed of an insulating resin material. The light sources 106 and the defogger 130 are coated with the masking material 134, thereby suppressing the light source light from proceeding to the front side of the vehicle while protecting the light sources 106 and the defogger 130. Also, in the present exemplary embodiment, although the electronic circuit 132 is provided in the rear window part 104, it may be provided in another region of such as, e.g., vehicle body side.

### Third Exemplary Embodiment

In the vehicular rear panel according to the third exemplary embodiment, a light source, a wiring, and a light emitting unit are provided at a curved portion of the rear window part. Hereafter, descriptions about the vehicular rear panel according to the present exemplary embodiment will be made based on the features different from those of the first exemplary embodiment. Also, the same configurations as those of the first exemplary embodiment will be assigned with the same symbols and the descriptions and illustrations of the configurations and the effects will be omitted.

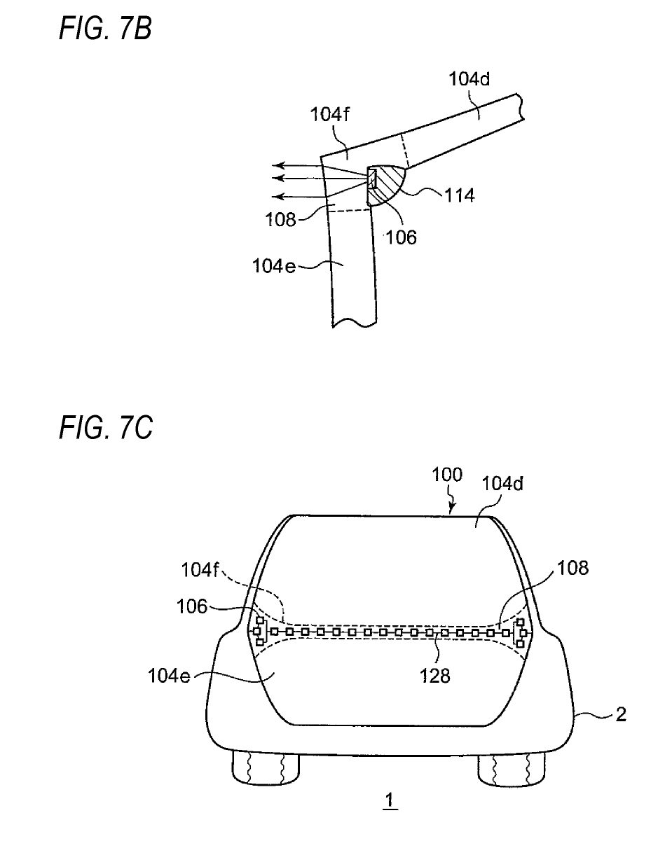

FIG. 7A is a schematic side view illustrating the rear part of the vehicle on which the vehicular rear panel according to the third exemplary embodiment is mounted. FIG. 7B is a schematic vertical cross-sectional view illustrating the rear window part in the vicinity of the curved portion. FIG. 7C is a schematic front view illustrating a configuration of the vehicular rear panel according to the third exemplary embodiment. The vehicular rear panel 100 according to the third exemplary embodiment is provided with the rear window part 104 which is formed with a first rear window part 104d and a second rear window part 104e. The first rear window part 104d inclines at a predetermined angle such that the height of the vehicle is gradually lowered from the front side of the vehicle toward the rear side of the vehicle in the rear vehicle body part 2. The second rear window part 104e extends from the end portion of the rear side of the vehicle of the first rear window part 104d with steeper inclination than that of the first rear window part 104d. In the present exemplary embodiment, the second rear window part 104e extends in the downward vertical direction from the end portion of the rear side of the vehicle of the first rear window part 104d. Also, the second rear window part 104e may extend to the rear of the vehicle with steeper inclination than that of the first rear window part 104d and may be folded toward the front side of the vehicle. A connecting part of the first rear window part 104d and the second window part 104e forms a curved portion 104f. The curved portion 104f is a region where scenery becomes discontinuous when viewed from a driver side.

The light source 106, the wiring 128, and the light emitting unit 108 are provided at the curved portion 104f. In the present exemplary embodiment, the curved portion 104f extends in the widthwise direction of the vehicle and the light sources 106 and the wiring 128 for electric power supply to the light sources 106 are arranged in the widthwise direction of the vehicle. A light shielding part 136 is provided in the front side of the vehicle of the light source 106. The vehicular rear panel 100 according to the present exemplary embodiment uses the curved part 104f, which is difficult to use for a driver's visibility of the rear side of the vehicle, for the region where the light sources 106, the wiring 128 and the light emitting unit 108 are provided. Accordingly, the deterioration of the driver's rear visibility caused by providing the light sources 106, the wiring 128, and the light emitting unit 108 on the rear window part 104 may be suppressed.

### Fourth Exemplary Embodiment

The vehicular rear panel according to the fourth exemplary embodiment is integrally formed with an information display member having a shape such as, for example, a letter or a figure on the rear window part. Hereafter, descriptions about the vehicular rear panel according to the present exemplary embodiment will be made based on the features different from those of the first exemplary embodiment. Also, the same configurations as those of the first exemplary embodiment will be assigned with the same symbols and the descriptions and illustrations of the configurations and the effects will be omitted.

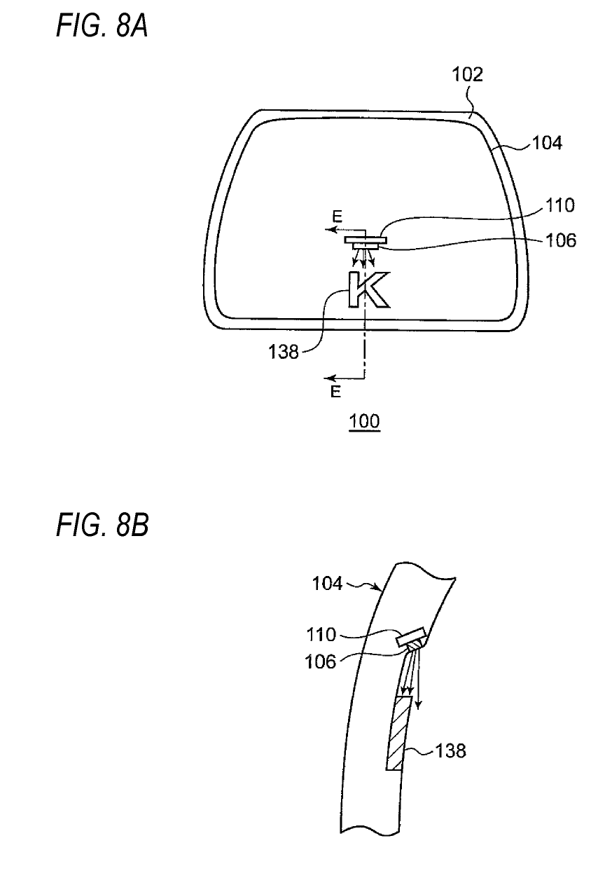

FIG. 8A is a schematic front view illustrating a configuration of the vehicular rear panel according to the fourth exemplary embodiment. FIG. 8B is a cross-sectional view taken along line E-E in FIG. 8A. The vehicular rear panel 100 according to the fourth exemplary embodiment is provided with an information display member 138 which has a shape such as, for example, a letter or a figure and is made of a colored or transparent resin material on the surface of the front side of the vehicle of the rear window part 104. The information display member 138 may has a shape such as, e.g., a maker logo or an emblem.

Also, a light source 106 and an FPC 110 as a wiring are embedded in the rear window part 104. The light source 106 is disposed so as to emit the light toward the information display member 138. Accordingly, when the light source 106 is turned ON, the shape of the information display member 138 may be caused to float on the rear window part 104. Further, if the information display member 138 is made of a colored resin material, the information display member 138 may be visible in the rear side of the vehicle even when the light source 106 is turned OFF.

### Fifth Exemplary Embodiment

The vehicular rear panel according to the fifth exemplary embodiment has a configuration in which, for example, the light source, the wiring for electric power supply, the defogger are embedded to the rear window part. Hereafter, descriptions about the vehicular rear panel according to the present exemplary embodiment will be made based on the fact which is different from the first exemplary embodiment. Also, the same configurations as those of the first exemplary embodiment will be assigned with the same symbols and the descriptions and illustrations of the configurations and the effects will be omitted.

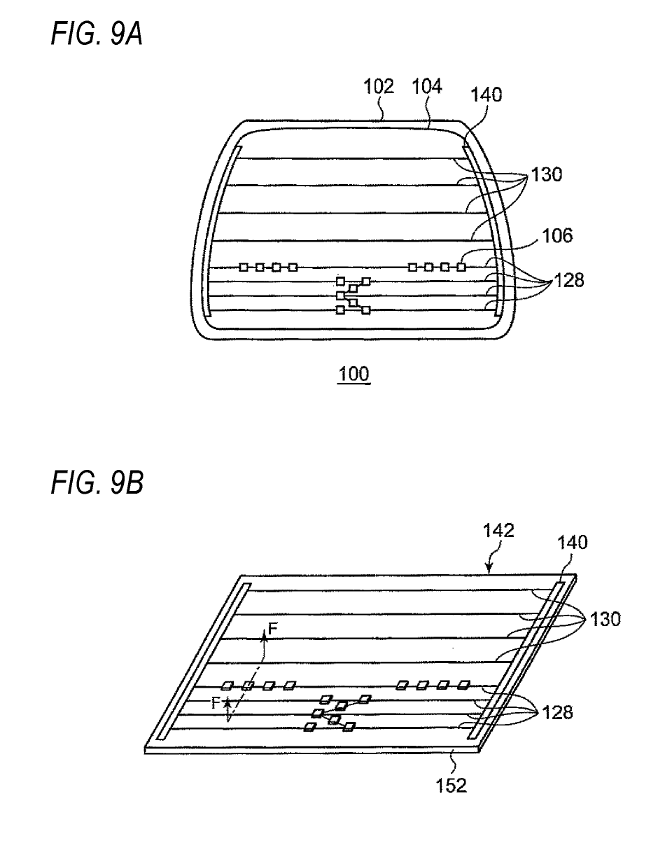

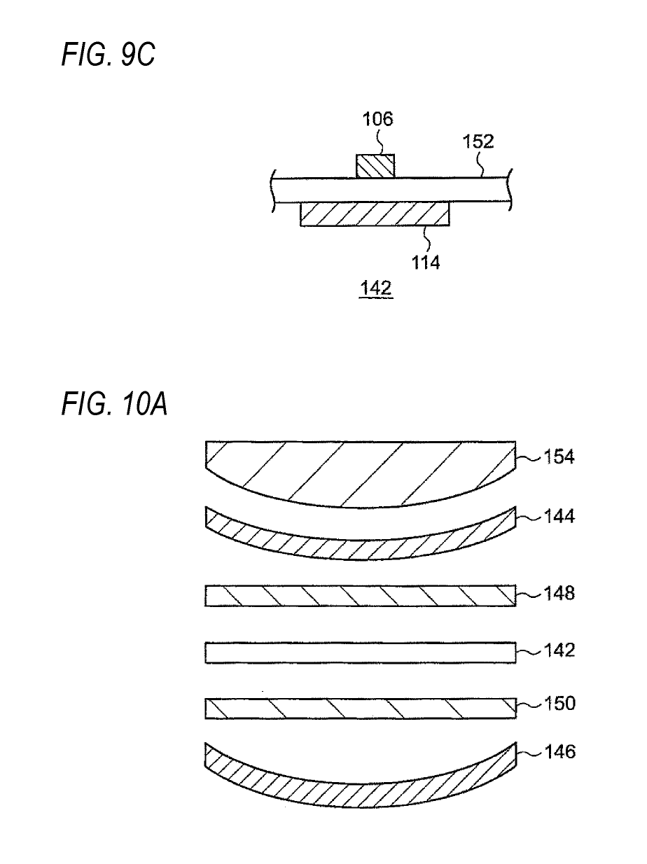

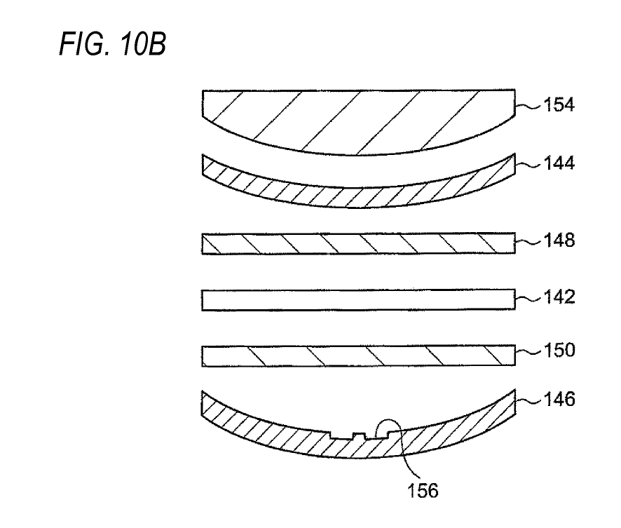

FIG. 9A is a schematic front view illustrating a configuration of the vehicular rear panel according to the fifth exemplary embodiment. FIG. 9B is a schematic perspective view illustrating a configuration of a light source implementation film. FIG. 9C is a cross-sectional view taken along line F-F in FIG. 9A. FIG. 10A is a cross-sectional view to describe a manufacturing method of a rear window part. In the vehicular rear panel 100 according to the fifth exemplary embodiment, a plurality of light sources 106, a wiring 128 for electric power supply, a defogger 130, and an electric power supply unit 140 to which the wiring 128 and the defogger 130 are connected are embedded in the rear window part 104 which is made of a resin material. More specifically, the rear window part 104 has a configuration in which a light source implementation film 142, a rear window inner panel 144, a rear window outer panel 146, a first sealing material 148, and a second sealing material 150 are stacked. The plurality of light sources 106 are disposed such that all or some of them form a letter or a figure. Accordingly, corresponding letter or figure may be caused to float on the rear window part 104.

The light source implementation film 142 includes a transparent resin film 152, the wiring 128 provided on one surface of the transparent resin film 152, the defogger 130, the electric power supply unit 140, the light sources 106, and the light shielding part 114 provided on the other surface of the transparent resin film 152. The wiring 128, the defogger 130, and the electric power supply unit 140 are formed by printing on the surface of the transparent resin film 152 using a conductive material. After the printing of the wiring 128, the light sources 106 are mounted. The light shielding part 114 is formed by printing using colored paint such as, e.g., black paint or blue paint. Also, the wiring 128 may form a portion of the defogger 130. The thickness of the light source mounting film 142 is, for example, about 0.2 mm to about 0.5 mm.

The rear window inner panel 144 and the rear window outer panel 146 may be manufactured using an acrylic material such as, e.g., polycarbonate resin or polymethyl metacrylate (PMMA) by injection molding. The rear window inner panel 144 and the rear window outer panel 146 are transparent members and have a curved shape according to the shape of the rear window part 104. The thickness of the rear window inner panel 144 is about 1 mm to about 3 mm and the thickness of the rear window outer panel 146 is about 2 mm to about 5 mm. The thickness of the rear window outer panel 146 may be set to be larger than that of the rear window inner panel. Accordingly, the light source 106 may be more securely protected from the external impact.

The first sealing material 148 and the second sealing material 150 are transparent sheet-shaped members formed from, for example, ethylene vinyl acetate copolymer (“EVA”). They become softened at 110° C. or more and serve as an adhesive. The thickness of each of the first sealing material 148 and the second sealing material 150 are, for example, 0.45 mm. The first sealing material 148 and/or the second sealing material 150 may be mixed with an infrared ray cut material or ultraviolet ray cut material (for example, a pigment). Especially, as for the second sealing material 150 stacked on the surface of the vehicle exterior side the light source implementation film 142, the second sealing material 150 may be mixed with the infrared rays cut material to protect the light sources 106 from infrared rays radiated from the outside.

The rear window part 104 may be manufactured by a laminate method which is well-known in the related art. That is, a laminate is obtained by laminating the rear window inner panel 144, the first sealing material 148, the light source implementation film 142, the second sealing material 150, and the rear window outer panel 146 in this order on a heating plate 154 having a convex curved surface according to the curved shape of the rear window inner panel 144 and the rear window outer panel 146. Also, the heating plate 154 and the entire laminated are covered with about a 10 mm-thick diaphragm rubber (not illustrated) and the air in the space between the diaphragm and the heating plate 154 is exhausted to form a vacuum state. The heat plate is set to and retained at about 135° C. for about 10 minutes to heat and compress the laminate. By the steps as described above, the rear window part 104 integrally formed with the light source implementation film 142 may be obtained.

Since the transparent film 152, the rear window inner panel 144, the rear window outer panel 146, the first sealing material 148, and the second sealing material 150 are transparent, a see-through configuration may also be implemented by the present exemplary embodiment.

As for the vehicular rear panel 100 according to the fifth exemplary embodiment, a modified example 6 below may be exemplified.

### MODIFIED EXAMPLE 6

FIG. 10B is a cross-sectional view to describe a manufacturing method of the rear window part of the vehicular rear panel according to the modified example 6. In the vehicular rear panel 100 according to the modified example 6, an uneven portion 156 having a shape, such as, e.g. a letter or a figure are integrally formed on the surface where the rear window outer panel 146 and the second sealing material 150 come in contact with each other. By providing the uneven portion 156 on the rear window outer panel 146, the rear window part 104 provided with undulation of a letter and a figure. Also, the uneven portion 156 may be provided on the location where it overlaps the arrangement of the light source 106 mounted on the transparent resin film 152 or where it does not overlap the arrangement of the corresponding light source 106. Further, the uneven portion 156 may be provided on the rear window inner panel 144.

The present disclosure is not limited to each of the above-described exemplary embodiments and modified examples. Each exemplary embodiment and each modified example may be combined and changes such as, e.g., various design changes may be made thereto based on the knowledge of a person skilled in the art. Such combinations or embodiments or modified examples where the changes are made are also included in the scope of the present disclosure. New exemplary embodiments obtained by combining the above-described respective exemplary embodiments or the respective modified examples and new exemplary embodiments obtained by combining the above-described respective exemplary embodiments or modified examples and the changes described below have respective effects of the combined exemplary embodiments, the modified examples and the changes in combination.

In the each of the above-described exemplary embodiments and modified examples, the light source 106 and the light emitting unit 108 may be provided in a region where the backdoor panel 102 is included, other than the rear window part 104. Also, a configuration in which the panel made of a resin material is provided with the light source and the light emitting unit and further a configuration in which the window part made of a resin material is provided with the light source and the light emitting unit may be applied not only to the vehicular rear panel but also, for example, to a vehicular side panel, a roof panel, or a front panel. The term, “transparent” in each of the above-described exemplary embodiments and the modified examples refers to “having light transmittance (light permeability)” and includes colored transparence other than colorless transparence.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicular rear panel comprising:
a light source which is at least partially disposed in the vehicular rear panel,
a wiring which is at least partially provided in the vehicular rear panel to supply electric power to the light source, and
a light emitting unit configured to emit light source light to the rear side of a vehicle,
wherein the rear panel is disposed on a rear vehicle body part and made of a resin material.

2. The vehicular rear panel of claim 1, further comprising a rear window part, wherein the light source, the circuit, and the light emitting unit are provided on the rear window part.

3. The vehicular rear panel of claim 2, wherein the rear window part has a curved portion where scenery becomes discontinuous when viewed from a driver side and the light source, the circuit, and the light emitting unit are provided at the curved portion.

4. The vehicular rear panel of claim 1, further comprising a light shielding part configured to suppress the light source light from proceeding toward the front of the vehicle.

5. The vehicular rear panel of claim 2, further comprising a light shielding part configured to suppress the light source light from proceeding toward the front of the vehicle.

6. The vehicular rear panel of claim 3, further comprising a light shielding part configured to suppress the light source light from proceeding toward the front of the vehicle.
